(19) United States
(12) Patent Application Publication
(10) Pub. No.: US 2021/0086444 A1
(43) Pub. Date: Mar. 25, 2021

(54) SYSTEM FOR ADDITIVELY MANUFACTURING A STRUCTURE

(71) Applicant: Continuous Composites Inc., Coeur d'Alene, ID (US)

(72) Inventors: Stephen Tyler WILSON, Coeur D'Alene, ID (US); Ryan C. Stockett, Spokane, WA (US)

(73) Assignee: Continuous Composites Inc., Coeur d'Alene, ID (US)

(21) Appl. No.: 16/947,328

(22) Filed: Jul. 28, 2020

Related U.S. Application Data
(60) Provisional application No. 62/904,999, filed on Sep. 24, 2019.

(51) Int. Cl. B29C 64/209; B33Y 30/00; B33Y 10/00; B29C 64/118; B33Y 40/20; B29C 64/40; B29C 64/393; B33Y 50/02

(52) U.S. Cl. CPC B29C 64/209; B33Y 30/00; B33Y 10/00; B33Y 50/02; B33Y 40/20; B29C 64/40; B29C 64/393; B29C 64/118

(57) ABSTRACT

A system is disclosed for us in additively manufacturing a structure. The system may include a chamber, a support, and a print head connected to and moveable by the support. The print head may be configured to discharge a structural material into the chamber to form a structure. The system may also include a supply device configured to direct a support material into the chamber around the structure.

### RELATED APPLICATION

This application is based on and claims the benefit of priority from U.S. Provisional Application No. 62/904,999 that was filed on Sep. 24, 2019, the contents of which are expressly incorporated herein by reference.

### TECHNICAL FIELD

The present disclosure relates generally to a manufacturing system and, more particularly, to a system for additively manufacturing a structure.

### BACKGROUND

Continuous fiber 3D printing (a.k.a., CF3D®) involves the use of continuous fibers embedded within a matrix discharging from a moveable print head. The matrix can be a traditional thermoplastic, a powdered metal, a liquid resin (e.g., a UV curable and/or two-part resin), or a combination of any of these and other known matrixes. Upon exiting the print head, a head-mounted cure enhancer (e.g., a UV light, an ultrasonic emitter, a heat source, a catalyst supply, etc.) is activated to initiate and/or complete curing of the matrix. This curing occurs almost immediately, allowing for unsupported structures to be fabricated in free space. When fibers, particularly continuous fibers, are embedded within the structure, a strength of the structure may be multiplied beyond the matrix-dependent strength. An example of this technology is disclosed in U.S. Pat. No. 9,511,543 that issued to Tyler on Dec. 6, 2016 (“the '543 patent”).

Although CF3D® provides for increased strength, compared to manufacturing processes that do not utilize continuous fiber reinforcement, improvements can be made to the structure and/or operation of existing systems. For example, Applicant has found that, when fabricating high-aspect ratio structures, flexibility within the structures during fabrication can cause fiber misalignments between overlapping layers and a general reduction in fiber placement accuracy.

The disclosed additive manufacturing system is uniquely configured to provide these improvements and/or to address other issues of the prior art.

### SUMMARY

In one aspect, the present disclosure is directed to an additive manufacturing system. The additive manufacturing system may include a chamber, a support, and a print head connected to and moveable by the support. The print head may be configured to discharge a structural material into the chamber to form a structure. The system may also include a supply device configured to direct a support material into the chamber around the structure.

In another aspect, the present disclosure is directed to a method of additive manufacturing. The method may include discharging a structural material through a print head into a chamber, and moving the print head relative to the chamber during discharging to form a structure. The method may also include directing a support material into the chamber around the structure.

### BRIEF DESCRIPTION OF THE DRAWINGS

FIG. 1 is a diagrammatic illustration of an exemplary disclosed additive manufacturing system;

FIG. 2 is a diagrammatic illustration of an exemplary disclosed support for a structure being fabricated by the additive manufacturing system of FIG. 1; and

FIGS. 3 and 4 are flowcharts depicting exemplary disclosed methods of controlling the additive manufacturing system of FIG. 1.

### DETAILED DESCRIPTION

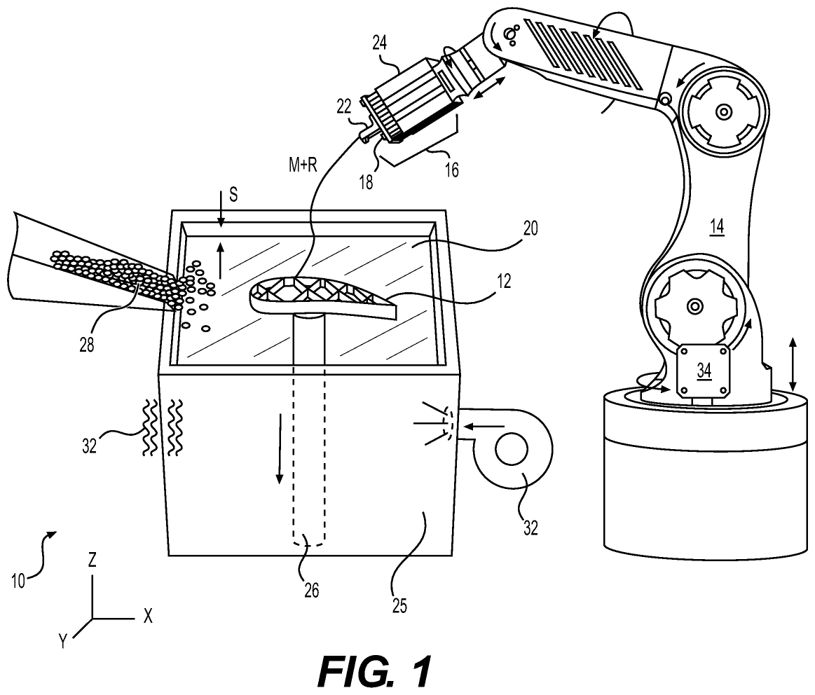

FIG. 1 illustrates an exemplary system 10, which may be used to manufacture a composite structure 12 having any desired shape. System 10 may include a support 14 and a deposition head (“head”) 16. Head 16 may be coupled to and moved by support 14. In the disclosed embodiment of FIG. 1, support 14 is a robotic arm capable of moving head 16 in multiple directions during fabrication of structure 12. Support 14 may alternatively embody a gantry (e.g., an overhead-bridge gantry or a single-post gantry) or a hybrid gantry/arm also capable of moving head 16 in multiple directions during fabrication of structure 12. Although support 14 is shown as being capable of 6-axis movements relative to structure 12, it is contemplated that support 14 may be capable of moving head 16 in a different manner (e.g., along and/or around a greater or lesser number of axes). It is also contemplated that structure 12 could be associated with one more movement axis and configured to move independent of and/or in coordination with support 14. In some embodiments, a drive may mechanically couple head 16 to support 14, and include components that cooperate to move portions of and/or supply power or materials to head 16.

Head 16 may be configured to receive or otherwise contain a matrix (shown as M). The matrix may include any type(s) or combination(s) of materials (e.g., a liquid resin, such as a zero-volatile organic compound resin, a powdered metal, etc.) that are curable. Exemplary resins include thermosets, single- or multi-part epoxy resins, polyester resins, cationic epoxies, acrylated epoxies, urethanes, esters, thermoplastics, photopolymers, polyepoxides, thiols, alkenes, thiol-enes, and more. In one embodiment, the matrix inside head 16 may be pressurized (e.g., positively and/or negatively), for example by an external device (e.g., by an extruder, a pump, etc.—not shown) that is fluidly connected to head 16 via a corresponding conduit (not shown). In another embodiment, however, the pressure may be generated completely inside of head 16 by a similar type of device. In yet other embodiments, the matrix may be gravity-fed into and/or through head 16. For example, the matrix may be fed into head 16, and pushed or pulled out of head 16 along with one or more continuous reinforcements (shown as R). In some instances, the matrix inside head 16 may need to be kept cool and/or dark in order to inhibit premature curing or otherwise obtain a desired rate of curing after discharge. In other instances, the matrix may need to be kept warm and/or illuminated for similar reasons. In either situation, head 16 may be specially configured (e.g., insulated, temperature-controlled, shielded, etc.) to provide for these needs.

The matrix may be used to at least partially coat any number of continuous reinforcements (e.g., separate fibers, tows, rovings, socks, and/or sheets of continuous material) and, together with the reinforcements, make up a portion (e.g., a wall) of composite structure 12. The reinforcements may be stored within or otherwise passed through head 16. When multiple reinforcements are simultaneously used, the reinforcements may be of the same material composition and have the same sizing and cross-sectional shape (e.g., circular, square, rectangular, etc.), or a different material composition with different sizing and/or cross-sectional shapes. The reinforcements may include, for example, carbon fibers, vegetable fibers, wood fibers, mineral fibers, glass fibers, plastic fibers, metallic fibers, optical fibers (e.g., tubes), etc. It should be noted that the term “reinforcement” is meant to encompass both structural and non-structural (e.g., functional) types of continuous materials that are at least partially encased in the matrix discharging from head 16.

The reinforcements may be at least partially coated with the matrix while the reinforcements are inside head 16, while the reinforcements are being passed to head 16, and/or while the reinforcements are discharging from head 16. The matrix, dry (e.g., unimpregnated) reinforcements, and/or reinforcements that are already exposed to the matrix (e.g., pre-impregnated reinforcements) may be transported into head 16 in any manner apparent to one skilled in the art. In some embodiments, a filler material (e.g., chopped fibers, nano particles or tubes, etc.) and/or additives (e.g., thermal initiators, UV initiators, etc.) may be mixed with the matrix before and/or after the matrix coats the continuous reinforcements.

One or more cure enhancers (e.g., a UV light, an ultrasonic emitter, a laser, a heater, a catalyst dispenser, etc.) 18 may be mounted proximate (e.g., within, on, and/or adjacent) head 16 and configured to enhance a cure rate and/or quality of the matrix as it is discharged from head 16. Cure enhancer 18 may be controlled to selectively expose portions of structure 12 to energy (e.g., UV light, electromagnetic radiation, vibrations, heat, a chemical catalyst, etc.) during material discharge and the formation of structure 12. The energy may trigger a chemical reaction to occur within the matrix, increase a rate of the chemical reaction, sinter the matrix, harden the matrix, solidify the matrix, polymerize the matrix, or otherwise cause the matrix to cure as it discharges from head 16. The amount of energy produced by cure enhancer 18 may be sufficient to cure the matrix before structure 12 axially grows more than a predetermined length away from head 16. In one embodiment, structure 12 is at least partially cured before the axial growth length becomes equal to an external diameter of the matrix-coated reinforcement.

The matrix and/or reinforcement may be discharged together from head 16 via any number of different modes of operation. In a first example mode of operation, the matrix and/or reinforcement are extruded (e.g., pushed under pressure and/or mechanical force) from head 16 as head 16 is moved by support 14 to create features of structure 12. In a second example mode of operation, at least the reinforcement is pulled from head 16, such that a tensile stress is created in the reinforcement during discharge. In this second mode of operation, the matrix may cling to the reinforcement and thereby also be pulled from head 16 along with the reinforcement, and/or the matrix may be discharged from head 16 under pressure along with the pulled reinforcement. In the second mode of operation, where the reinforcement is being pulled from head 16, the resulting tension in the reinforcement may increase a strength of structure 12 (e.g., by aligning the reinforcements, inhibiting buckling, equally loading the reinforcements, etc.) after curing of the matrix, while also allowing for a greater length of unsupported structure 12 to have a straighter trajectory. That is, the tension in the reinforcement remaining after curing of the matrix may act against the force of gravity (e.g., directly and/or indirectly by creating moments that oppose gravity) to provide support for structure 12.

The reinforcement may be pulled from head 16 as a result of head 16 being moved by support 14 away from an anchor (e.g., a print bed, a previously fabricated surface of structure 12, a fixture, etc.) 20. For example, at the start of structure formation, a length of matrix-impregnated reinforcement may be pulled and/or pushed from head 16, deposited against anchor 20, and at least partially cured, such that the discharged material adheres (or is otherwise coupled) to anchor 20. Thereafter, head 16 may be moved away from anchor 20, and the relative movement may cause the reinforcement to be pulled from head 16. In some embodiments, the movement of reinforcement through head 16 may be selectively assisted via one or more internal feed mechanisms, if desired. However, the discharge rate of reinforcement from head 16 may primarily be the result of relative movement between head 16 and anchor 20, such that tension is created within the reinforcement. As discussed above, anchor 20 could be moved away from head 16 instead of or in addition to head 16 being moved away from anchor 20.

Head 16 may include, among other things, an outlet 22 and a matrix reservoir 24 located upstream of outlet 22. In one example, outlet 22 is a single-channel outlet configured to discharge composite material having a generally circular, tubular, or rectangular cross-section. The configuration of head 16, however, may allow outlet 22 to be swapped out for another outlet that simultaneously discharges multiple channels of composite material having the same or different shapes (e.g., a flat or sheet-like cross-section, a multi-track cross-section, etc.). Fibers, tubes, and/or other reinforcements may pass through matrix reservoir 24 (e.g., through one or more internal wetting mechanisms located inside of reservoir 24) and be wetted (e.g., at least partially coated, encased, and/or fully saturated) with matrix prior to discharge.

It has been found that, while fabricating structures 12 having a high-aspect ratio (i.e., ratio of height in a Z-direction to dimension in an X- and/or Y-direction), a small base, intricate features, etc., the structures 12 can become unstable. For example, forces exerted in the X- and/or Y-direction via the reinforcement extending between structure 12 and print head 16 and/or being pulled out of head 16 and in a direction away from structure 12 can cause structure 12 to flex, bend, and/or break away from a desired location. This movement can cause misalignment between reinforcements of overlapping layers and other inaccuracies, thereby limiting an overall height of structure 12 that can be printed.

To facilitate fabrication of high-aspect ratio structures 12, print head 16 may be configured to discharge a base layer onto anchor 20 at a location inside of a build chamber 25. Additional layers may then be anchored to and/or laid down on top of the base layer, such that structure 12 grows in a Z-direction.

An elevator 26 (e.g., an electric, hydraulic, pneumatic, and/or manually operated elevator) may be associated with anchor 20 and configured to incrementally lower anchor 20 down into chamber 25. It is contemplated that elevator 26 may be controlled to lower anchor 20 in preparation for each new layer of structure 12, or that elevator 26 may lower anchor 20 only after a set number of layers have been fabricated (e.g., every 5 or 10 layers). Regardless of the strategy used to lower anchor 20 into build chamber 25, each time that structure 12 is moved downward in the Z-direction, a space S may be generated around structure 12 within chamber 25. This space S may have a depth about (i.e., within engineering tolerances) equal to the downward step of structure 12. It is contemplated that, instead of or in addition to elevator 26 stepping anchor 20 downward in the Z-direction, walls of chamber 25 could be moved upward and/or built higher in the Z-direction to generate space S.

At one or more times during fabrication of structure 12 (e.g., after each step down), the space S generated around structure 12 within chamber 25 may be selectively filled with a support material (“material”) 28. Material 28 may include, for example, heat-conducting spheres (e.g., metal shot), insulating spheres (e.g., glass beads), a granular material, an electrorheological fluid, or another material known in the art having any desired shape, size, makeup, consistency, and/or viscosity. Material 28 may have a composition and/or chemical makeup different from that of the matrix and/or reinforcements used to fabricate structure 12. A spherical shape and/or fluidic makeup of material 28 having a smaller particle size may facilitate flow of the material around structure 12, increase heat transfer, and/or inhibit the material from balancing atop uppermost reinforcements deposited as part of the previously discharged layer. Non-spherical shapes of material 28 having a greater density may form a more rigid support around structure 12. Larger sizes of material 28 may provide greater porosity and flow around material 28.

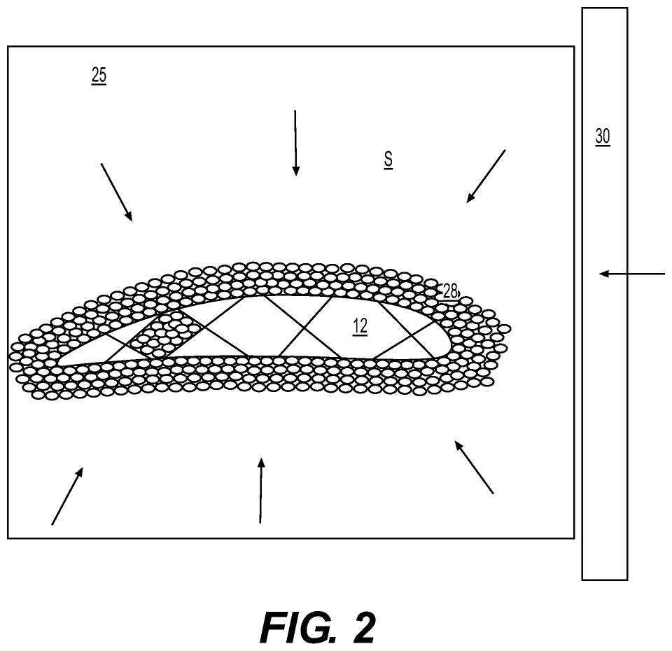

Material 28 may be passed into chamber 25 in multiple different ways. For example, the support material 28 may be funneled into chamber 25 with the assistance of gravity (shown in FIGS. 1 and 2) and/or vibrations (e.g., from a vibration source associated with the depicted funnel), pushed into and/or over the space S via an arm 30, blown into the space S via gas pressure, or supplied in another similar manner via another supply device. It is contemplated that material 28 may fill only the space S around structure 12 or also fill voids within structure 12, as desired. Material 28 may shore up and stabilize structure 12, such that structure 12 may be built up further in the Z-direction with reduced risk of misalignment between layers and/or warping, bending, or sagging of structure 12.

In some embodiments, cure enhancer(s) 18 may function to only cure an outer shell of the discharging composite material, such that a shape of structure 12 is maintained during filling of space S with material 28. In these embodiments, matrix inside of the outer shell and/or adjacent an underlying layer may not be fully cured. Unless accounted for, this can reduce properties of structure 12.

One way to promote through-curing of structure 12, without transferring structure 12 to a dedicated curing device (e.g., an oven), may be to provide additional cure energy via material 28. For example, energy may be passed from one or more sources 32 into build chamber 25 at a level below and/or within space S. In particular, the energy may be passed through voids (e.g., via convection) between adjacent particles of material 28 and/or directly through the particles (e.g., through metallic and/or transparent glass particles) themselves (e.g., via conduction). Sources 32 may include, for example, a pressure source (e.g., a pump, a fan, etc.) of heated and/or chilled inert or reactive fluid (e.g., gas and/or liquid), heating and/or cooling coils, light sources, and other sources known in the art.

In one specific embodiment, particles of material 28 may be coated with a binder (e.g., a thermoplastic film) that binds adjacent particles together when exposed to energy from sources 32. For example, the film may melt and coalesce in the spaces between the particles and, thereby, create a lattice support. This may enhance a supporting capability of material 28. It is contemplated that a bond strength of the binder may be lower than a bond strength of the cured matrix within structure 12, such that material 28 may still be easily removed from structure 12 after fabrication of structure 12 is complete. Alternatively or additionally, exposure of the energy from sources 32 at a temporary higher level (e.g., at an end of the curing process) may cause the coalesced film to completely melt away from the particles and collect within a bottom of chamber 25 or evaporate, leaving only loose particles that easily separate away from structure 12.

One or more controllers 34 may be provided and communicatively coupled with support 14 and head 16. Each controller 34 may embody a single processor or multiple processors that are programmed and/or otherwise configured to control an operation of system 10. Controller 34 may include one or more general or special purpose processors or microprocessors. Controller 34 may further include or be associated with a memory for storing data such as, for example, design limits, performance characteristics, operational instructions, tool paths, and corresponding parameters of each component of system 10. Various other known circuits may be associated with controller 34, including power supply circuitry, signal-conditioning circuitry, solenoid driver circuitry, communication circuitry, and other appropriate circuitry. Moreover, controller 34 may be configured to communicate with other components of system 10 via wired and/or wireless transmission.

One or more maps may be stored within the memory of controller 34 and used during fabrication of structure 12. Each of these maps may include a collection of data in the form of lookup tables, graphs, and/or equations. In the disclosed embodiment, controller 34 may be programmed to use the maps and determine movements of head 16 and/or elevator 26 required to produce desired geometry (e.g., size, shape, material composition, performance parameters, and/or contour) of structure 12 and/or to regulate operation of cure enhancer(s) 18, source(s) of material 28 (e.g., the funnel, arm 30, etc.), sources 32, elevator 36, and/or other related components in coordination with the movements.

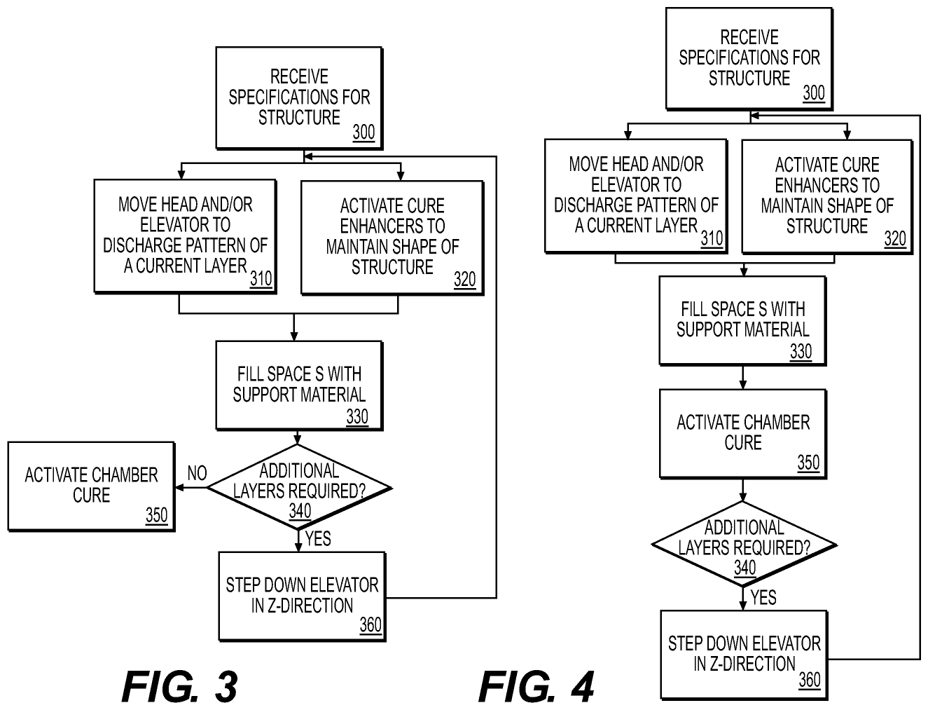

FIGS. 3 and 4 are flowcharts depicting exemplary methods performed by controller 34 during operation of system 10. These figures will be discussed in more detail in the following section to further illustrate the disclosed concepts.

### INDUSTRIAL APPLICABILITY

The disclosed system may be used to manufacture composite structures having any desired shape and size. The disclosed system may be particularly useful in manufacturing composite structures having a high-aspect ratio. The composite structures may be fabricated from any number of different fibers of the same or different types and of the same or different diameters, and any number of different matrixes of the same or different makeup. Operation of system 10 will now be described in detail, with reference to FIGS. 3 and 4.

At a start of a manufacturing event, information regarding a desired structure 12 may be loaded into system 10 (e.g., received by controller 34 that is responsible for regulating operations of system 10—Step 300). This information may include, among other things, a size (e.g., diameter, wall thickness, length, etc.), a contour (e.g., a trajectories, surface normal, etc.), surface features (e.g., ridge size, location, thickness, length; flange size, location, thickness, length; etc.), connection geometry (e.g., locations and sizes of couplings, tees, splices, etc.), reinforcement selection and specification, matrix selection and specifications, discharge locations and conditions, curing specifications, support specifications, etc. It should be noted that this information may alternatively or additionally be loaded into system 10 at different times and/or continuously during the manufacturing event, if desired.

The component information may then be used by controller 34 to control operations of system 10. For example, the in-situ wetted reinforcements may be pulled and/or pushed from outlet 22 of head 16 as support 14 selectively moves head 16 relative to anchor 20 (e.g., based on known kinematics of support 14, head 16, and anchor 20 and based on desired geometry of structure 12), such that the resulting structure 12 is fabricated as desired (Step 310). At this same time, controller 34 may be programmed to selectively activate one or more of cure enhancers 18 to expose the material discharging from outlet 22 of head 16 to cure energy (Step 320). As indicated above, this cure energy may be sufficient to completely cure the matrix within the material or sufficient to cure only an outer surface of the material, allowing the material to maintain its form during infill of support material 28 around and/or inside of structure 12.

Controller 34 may further be programmed to determine if the current layer is the only or final layer to be discharged or if additional layers are required to complete fabrication of structure 12 (Step 340). If no additional layers are required (Step 340:N), controller 34 may be programmed to activate curing of the fully discharged structure (e.g., via activation of source(s) 32) inside of build chamber 25. Sources 32 may be active for any desired duration(s) at any desired intensity level(s) required to provide a corresponding degree of cure within structure 12. For example, sources 32 could be activated to provide a curing profile with ramping intensity levels, variable dwell times, variable cure energy types, etc.

Returning to Step 340, when additional layers of material discharge are required to complete fabrication of structure 12, controller 34 may be programmed to instead cause elevator 26 to step down in the Z-direction one thickness corresponding to a next layer to be discharged. Control may then return to Steps 310 and 320. That is, in the embodiment of FIG. 3, curing within chamber 25 may be inhibited until all layers of structure 12 have been discharged.

It is contemplated that elevator 26 could be controlled in only a feedforward manner, in only a feedback manner, in a hybrid manner, or in any other manner. For example, controller 34 may be configured to generate a signal directed to elevator 26 after completion of each layer, the signal being calibrated from lab testing to cause elevator 26 to step down a desired distance. Alternatively or additionally, a sensor could be provided that measures motion of elevator 26 and provides the measurement as feedback to controller 34, allowing controller 34 to cause motion of elevator 26 until a desired position is reached. In yet another example, after completion of a particular layer, elevator 26 could be manually lowered the above-described feedback responsively generated and directed to controller 34.

In the alternative embodiment of FIG. 4, steps similar to those of FIG. 3 may be performed, albeit in a different order. That is, in the embodiment of FIG. 4, curing within chamber 25 via activation of source(s) 36 may be implemented only during or also after discharge of each layer of structure 12. It should be noted that, after all layers of structure 12 have been discharged and curing within chamber 25 has been implemented throughout discharging, an additional and/or different cure profile may be implemented within chamber 25, if desired.

As discussed above, multiple benefits may be associated with the disclosed system. For example, structure 12 may be supported throughout fabrication with material 28 that is easily separated from structure 12 (e.g., simple drawn away, allowed to fall away, etc.) when fabrication is complete. This may allow fabrication of high-aspect ratio structures, as well as delicate structures (e.g., structures with overhangs, small bases, thin lattices, etc.). In addition, more intricate and/or thorough curing of structure 12 may be implemented, without having to move structure 12 from where it was fabricated. This may help ensure higher material properties, with enhanced structural accuracies.

It will be apparent to those skilled in the art that various modifications and variations can be made to the disclosed system. Other embodiments will be apparent to those skilled in the art from consideration of the specification and practice of the disclosed system. For example, although material 28 is disclosed as being added into chamber 25 during fabrication, it is contemplated that the material could be selectively removed from particular areas of chamber 25 for completion of particular features of structure 12. That is, material 28 could be added at one point in time to support and/or promote curing of the features, and then removed at another point to provide additional access to the features. During this subtraction of material 28, elevator 26 could be selectively raised and/or the material removed via spillage, via engagement with arm 30, via a dedicated removal tool (e.g., a vacuum, siphon, magnet, etc.), or in another manner. It is intended that the specification and examples be considered as exemplary only, with a true scope being indicated by the following claims and their equivalents.

What is claimed is:

1. An additive manufacturing system, comprising:
a chamber;
a support;
a print head connected to and moveable by the support, the print head configured to discharge a structural material into the chamber to form a structure; and
a supply device configured to direct a support material into the chamber around the structure.

2. The additive manufacturing system of claim 1, wherein the structural material includes a continuous reinforcement coated in a matrix.

3. The additive manufacturing system of claim 2, wherein the support material is different from a material of the continuous reinforcement and a material of the matrix.

4. The additive manufacturing system of claim 1, further including a cure source configured to direct cure energy into the chamber.

5. The additive manufacturing system of claim 4, wherein the cure source is configured to direct the cure energy into the chamber through at least one of the support material and voids between the support material.

6. The additive manufacturing system of claim 4, further including a controller programmed to cause the print head to discharge all layers of the structure before activating the cure source.

7. The additive manufacturing system of claim 4, further including a controller programmed to activate the cure source after each layer of the structure is discharged by the print head.

8. The additive manufacturing system of claim 4, further including a controller programmed to activate the cure source during discharge by the print head.

9. The additive manufacturing system of claim 4, wherein the cure energy is one of light, heat, and a reactive medium.

10. The additive manufacturing system of claim 9, further including a cure enhancer configured to at least partially harden the structural material prior to the supply device directing the support material into the chamber around the structure.

11. The additive manufacturing system of claim 10, wherein the cure enhancer is configured to generate a cure energy different from the cure energy generated by the cure source.

12. The additive manufacturing system of claim 1, further including a cure enhancer configured to at least partially harden the structural material prior to the supply device directing the support material into the chamber around the structure.

13. The additive manufacturing system of claim 1, further including:
an anchor inside the chamber on which the structure is fabricated; and
an elevator connected to the anchor; and
a controller in communication with the elevator, the controller being configured to cause the elevator to step down the anchor a greater depth into the chamber after each layer of the structure is discharged from the print head.

14. A method of additively manufacturing a structure, comprising:
discharging a structural material through a print head into a chamber;
moving the print head relative to the chamber during discharging to form a structure; and
directing a support material into the chamber around the structure.

15. The method of claim 14, wherein the support material is different from the structural material.

16. The method of claim 14, further including directing a cure energy into the chamber through at least one of the support material and voids between the support material.

17. The method of claim 16, wherein directing the cure energy into the chamber includes directing at least one of light, heat, and a reactive medium into the chamber.

18. The method of claim 16, wherein the cure energy is a first cure energy, and the method further includes exposing the structural material to a second cure energy to maintain a form of the structure prior to directing the support material into the chamber around the structure.

19. The method of claim 18, wherein the first cure energy is different from the second cure energy.

20. The method of claim 14, further including at least partially hardening the structural material prior to directing the support material into the chamber around the structure.
